(19) United States
(12) Patent Application Publication
(10) Pub. No.: US 2011/0311180 A1
(43) Pub. Date: Dec. 22, 2011

(54) Glassy Surface Smoothing Layer for Integrated Waveguide

(75) Inventors: Juejun Hu, Newark, DE (US); Nathan A. Carlie, Waverly, PA (US); Laeticia C. Petit, Lohja (FI); Anuradha M. Agarwal, Weston, MA (US); Kathleen A. Richardson, Clemson, SC (US); Lionel C. Kimerling, Concord, MA (US)

(73) Assignees: CLEMSON UNIVERSITY, Clemson, SC (US); MASSACHUSETTS INSTITUTE OF TECHNOLOGY, Cambridge, MA (US)

(21) Appl. No.: 13/106,986

(22) Filed: May 13, 2011

Related U.S. Application Data
(60) Provisional application No. 61/334,622, filed on May 14, 2010.

(51) Int. Cl. G02B 6/12

(52) U.S. Cl. 385/14; 427/163.2

(57) ABSTRACT

An integrated optical waveguide includes a substrate, a waveguide under-cladding layer disposed on the substrate, and a waveguide core, having top and sidewall surfaces, disposed on the under-cladding layer. A glassy surface smoothing layer disposed on the waveguide core top surface and sidewall surfaces and has a refractive index, relative to a refractive index of the waveguide core, that enables guided optical transmission through the waveguide core and the glassy surface smoothing layer. In fabrication of the optical waveguide, a waveguide under-cladding layer is formed on a substrate and a waveguide core having sidewall surfaces and a top surface is formed on the under-cladding layer. A liquid suspension comprising particles of a glassy material is applied on the top and sidewall surfaces of the waveguide core. The applied liquid glassy particle suspension is heated to form a glassy surface smoothing layer on the waveguide core top surface and sidewall surfaces.

### CROSS-REFERENCE TO RELATED APPLICATIONS

This application claims the benefit of U.S. Provisional Application No. 61/334,622, filed May 14, 2010, the entirety of which is hereby incorporated by reference.

### STATEMENT REGARDING FEDERALLY SPONSORED RESEARCH

This invention was made with Government support under Contract No. DE-SC52-06NA27341 and Contract No. DE-FG52-06NA27502, funded by the Department of Energy. The Government has certain rights in the invention.

### BACKGROUND

This invention relates generally to microphotonics, and in particular relates to techniques for reducing optical transmission loss in integrated waveguiding devices.

Integrated waveguides, that is, optical waveguides that are monolithically integrated on a substrate in a planar fashion, provide a range of technical competitive advantages over their fiber waveguide counterparts, including superior robustness, small footprint, and compatibility with other planar optoelectronic devices. With these unique characteristics, integrated optical waveguides have become the key building block for many optical device applications, including optical data communications, light emission, optical computing, and waveguide sensing.

The leading performance measure for any optical waveguide is the level of transmission loss for the waveguide, and low transmission loss is important for realizing many optical applications such as those described above. For example, in a Fabry-Perot laser, low optical loss in the integrated waveguide cavity of the laser reduces the lasing threshold and improves slope efficiency. In a waveguide-based evanescent biochemical sensor, the sensitivity of the sensor is inversely proportional to the waveguide optical loss. Low-loss waveguide design and fabrication is currently considered to be significantly important to enable an array of optical device applications.

In general, the optical loss that is characteristic of an integrated waveguide is caused by a number of factors, including material absorption, substrate leakage, and surface roughness scattering. The optimization of material quality can reduce material absorption, and the optimization of waveguide geometry can reduce substrate leakage. But optical scattering caused by surface roughness has conventionally not been easily reduced, and is in general the dominant source of optical loss for many waveguide systems.

Scattering loss due to surface roughness is proportional to the ratio between the refractive index of the core of the waveguide and the refractive index of waveguide cladding materials. As a result, scattering loss can be particularly severe for high-index-contrast waveguide systems, such as those in which the difference in refractive index difference between waveguide core and waveguide cladding is greater than about 0.5. This high-index-contrast scattering loss has become a dominant limitation for the field of integrated waveguides because the most important optoelectronics and photonics application rely on such systems, including, silicon-silicon dioxide, silicon (oxy)nitride-silicon oxide, chalcogenide glasses, and III-V compound semiconductor waveguide systems.

### SUMMARY OF THE INVENTION

There is provided a waveguide design and fabrication process that reduces the optical scattering loss that is characteristic of surface roughness in integrated waveguides. In an example of such an integrated optical waveguide, there is provided a substrate, a waveguide under-cladding layer disposed on the substrate, and a waveguide core, having a top surface and having sidewall surfaces, that is disposed on the under-cladding layer. A glassy surface smoothing layer is disposed on the waveguide core top surface and sidewall surfaces. The glassy surface smoothing layer is characterized by a refractive index, relative to a refractive index that is characteristic of the waveguide core, that enables guided optical transmission through the waveguide core and the glassy surface smoothing layer.

In one example fabrication sequence for producing the integrated optical waveguide, a waveguide under-cladding layer is formed on a substrate and a waveguide core having sidewall surfaces and a top surface is formed on the under-cladding layer. A liquid suspension comprising particles of a glassy material is applied on the top and sidewall surfaces of the waveguide core. The applied liquid glassy particle suspension is heated to form a glassy surface smoothing layer on the waveguide core top surface and sidewall surfaces.

With this design and fabrication sequence, there can be produced a first waveguide core region and a second waveguide core region formed on the first region by application of a liquid glassy particle suspension. The refractive index of the waveguide core can be substantially equal through the first and second waveguide core regions.

This integrated waveguide can achieve an optical loss reduction of as much as 50% over conventional integrated waveguide designs. Such a significant optical loss reduction enables the realization of superior performance for a wide range of photonic systems, including lift-off-defined optical systems, such as optical resonators, by producing increased sensitivity, e.g., though enhanced Q-factor. Other features and advantages of the invention will be apparent from the following description and accompanying figures, and from the claims.

### BRIEF DESCRIPTION OF THE DRAWINGS

FIGS. 1A-1C are schematic representations of the steps in a process for forming a glassy surface smoothing layer on a waveguide core;

FIGS. 2A-2D are schematic cross-sectional views of a waveguide during fabrication and formation of a glassy surface smoothing layer on the waveguide core;

FIG. 3 is a plot of the experimentally-measured surface roughness along a waveguide core sidewall, as determined by atomic force microscopy scan, for an experimental glass waveguide core and is a plot of the experimentally-measured surface roughness along a waveguide core sidewall for the glass waveguide core including a glassy surface smoothing layer; and

FIG. 4 is a plot of relative optical loss at 1550 nm for experimental glass waveguide cores as a function of the spin speed and hard-bake temperature employed in the production of a glassy surface smoothing layer on the waveguide cores.

### DETAILED DESCRIPTION

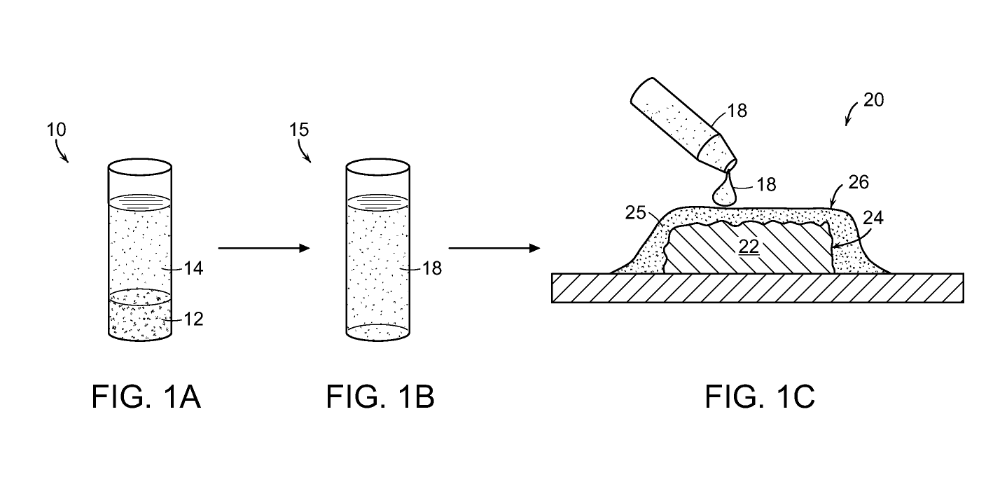

FIGS. 1A-1C schematically represent an example sequence of steps for providing a surface smoothing layer on a waveguide core for smoothing the waveguide core sidewalls to reduce waveguide scattering loss. In a first example step 10, particles 12 of a selected material for which it is desired to form a smoothing layer are provided with a compatible liquid solvent 14 for dissolution of the particles in the solvent. In a second step 15 a solution suspension 18 of the material particles in the solvent is produced. In a final step 20, the solution suspension 18 is applied to a waveguide core, covering the sidewall surfaces 24 of the waveguide core, and a surface smoothing layer 25 is formed on the waveguide core. Thus, the material composition of the surface smoothing layer 25 is deposited from a solution 18 onto the waveguide core 22 and in particular, the waveguide core sidewalls 24, which may exhibit significant roughness. The surface tension of the solution 18 leads to a smooth surface 26 of the surface smoothing layer 25. For waveguides in which the refractive index of the surface smoothing layer is similar to that of the waveguide core, the interface between the core and the surface smoothing layer is thereby effectively eliminated for purposes of guided wave optics, and any roughness at the core sidewall surfaces does not contribute to scattering loss in the waveguide.

The surface smoothing layer can be formed from any suitable fluidic suspension of a dissolved species, such as particles from a bulk material, that accommodates solution processing and solution deposition on a waveguide core, including waveguide sidewalls. For many waveguide applications, a glassy surface smoothing layer can be preferred. The amorphous morphology that is characteristic of glassy material layers produces a surface smoothing layer with no lattice mismatch with an underlying waveguide core material. For example, Ge—Sb—S and As—S chalcogenide glass systems are soluble in basic organic solvents such as amines, and are amenable to solution processing for deposition from liquid onto a crystalline waveguide core structure. In addition, the wide compositional range and almost unlimited capacity of many types of glasses, including, e.g., chalcogenides, heavy metal oxides, and halides, lead to a large tunability of glass properties, including refractive index and glass solubility for formation of a fluidic suspension of dissolved glass.

For almost any waveguide core material, there can be identified a glass composition having a refractive index that substantially matches that of the waveguide core material. As a result, it can be preferred to optimize the constituents of the glassy surface smoothing layer to eliminate a rough waveguide core interface by effectively moving the interface from the location of the core sidewalls 24 to the smooth surface 26 of the surface smoothing layer 25, to thereby reduce or eliminate sidewall roughness contribution to scattering loss, for almost any waveguide core material. With this configuration, the waveguide core can be said to be composed of a first waveguide core region that includes sidewalls and a second waveguide core region that is formed on the first waveguide core region from a suspension of glassy material particles. With proper selection of the glassy material, the refractive index of the first and second waveguide core regions are substantially equal.

It is recognized that, as shown in FIG. 1C, the addition of a glassy surface smoothing layer to a waveguide core adds to the waveguide core height as well as the waveguide core width. The surface smoothing layer is thin enough to generally follow the original waveguide core profile, but rounds the profile and produces sloping, tapered sidewalls, as compared with the as-fabricated waveguide core. A surface smoothing layer thickness of, e.g., between about 50 nm and about 1 μm can be employed for a wide range of applications, e.g., at telecommunication wavelengths. With this thickness, the surface smoothing layer thereby retains the general waveguide core geometry in that the waveguide core and deposited surface smoothing layer still includes sidewalls, which are now tapered sidewalls; the smoothing layer does not fill in the volume around the waveguide to form a planar surface across the substrate in the manner of an upper cladding layer.

The increased size of the waveguide core that results from the surface smoothing layer alters the mode profile of the waveguide, but can be compensated for in the design of the bare, uncoated waveguide core. Specifically, with the thickness and refractive index of the smoothing layer known a priori, the waveguide core region design can provide compensation so that the waveguide core-smoothing layer combination attains the original optical performance. For example, the waveguide core can be fabricated with a reduced width and/or height that takes into account the thickness and height of the surface smoothing layer, so that with the surface smoothing layer in place, a mode profile similar to that of a bare waveguide core can be achieved.

In general, inorganic glassy materials are characterized by a relatively high refractive index. For example, As—Sb—Se—Te alloys can have a refractive index as high as 3.5 near a wavelength of 1550 nm, enabling index matching of such an alloy to a number of technically important semiconductor materials, including Si and Ga(Al)As. In general, the high refractive index of inorganic glass materials present a major advantage over polymer materials, which are characterized by refractive indices of <1.7 and thus which cannot be employed as a surface smoothing layer for high-index-contrast waveguide material systems.

Any suitable inorganic glassy material can be employed for the glassy surface smoothing layer. Chalcogenides, halides, heavy metal oxides (HMOs), tellurites, and alloys of all of these are particularly well-suited for the glass surface smoothing layer. Chalcogenides are characterized by a refractive index of between about 2 and about 3.5 and are well-matched as a surface smoothing material to a waveguide core material of chalcogenides, silicon, GaAs, AlAs, and other III-V semiconductors. Halides are characterized by a refractive index of between about 1.5 and about 2.4; tellurites are characterized by a refractive index of between about 1.8 and about 2.2; and heavy metal oxides are characterized by a refractive index of between about 1.5 and about 2.5. These classes of glassy materials are therefore well-matched as a surface smoothing material to a waveguide core material of, e.g., silicon oxynitride (SiOₓN_{y}), silicon nitrides (SiNₓ), LiNbO₃, and a wide range of other glass compositions.

With these examples, it is shown that the surface smoothing layer can be provided as a material, such as a glassy material, that is characterized by a refractive index that is different than that of a waveguide core, that is similar to or substantially the same as that of a waveguide core, or that is purposefully offset from that of the waveguide core to produce a graded index arrangement between a waveguide core and one or more over-cladding layers, as described in detail below, with the surface smoothing layer refractive index being lower than that of the waveguide core but higher than that of the waveguide cladding material.

The waveguide core can therefore be provided as any suitable material for a given optical application. The waveguide core material can include, e.g., a crystalline inorganic material such as silicon, germanium, SiOₓN_{y}, a chalcogenide glass, a III-V semiconductor, e.g. GaAs, or other selected material. Undercladding and over-cladding of the waveguide core can be accomplished with a selected material such as an oxide, nitride, glassy material, or other suitable material having a refractive index that is suitable for optical guiding in the selected waveguide core material.

Considering now an example process for producing a glassy surface smoothing layer, first is produced a bulk glass having a selected glass composition desired for the smoothing layer. In one example glass production technique, raw starting glass materials are melted from high-purity starting elements that are weighed, preferably in a nitrogen-purged glove box, and then sealed in a quartz ampoule by, e.g., a gas-oxygen torch, preferably under vacuum. Prior to sealing the elements in the ampoule, it is preferable to pre-heat the ampoule and the raw materials to, e.g., about 100° C., while under high vacuum, for about, e.g., 4 hours, to remove surface moisture from the ampoule and from the batch raw materials. After sealing the weighed elements in the ampoule, the elements can be melted at a temperature corresponding to the melting points of the raw materials. For example, given a selected glass composition of Ge₂₃Sb₇S₇₀, a melt temperature of about 925° C. and a melt duration of, e.g., about 24 hours can be employed to melt the raw starting materials. A rocking furnace can be preferred for this melting step to increase homogeneity of the melt. Once fully homogenized, the melt-containing ampoule can be air-quenched to room temperature. To avoid fracture of the tube and the glass ingot therein, it can be preferred to subsequently return the glass to the furnace for annealing for, e.g., about 15 hours at a temperature that is about 40° C. below the glass transition temperature.

With a selected bulk glass composition produced, the glass can be manually or mechanically ground into a fine powder for dissolution in a liquid to be applied to a waveguide core. A fine powder size of between about, e.g., 10 μm and about 100 μm, can be preferred to increase the surface area of the material to be dissolved and thereby to shorten the dissolution time. The dissolution of the powder in a selected solvent is preferably carried out in a sealed glass container to prevent solvent evaporation. A magnetic stirrer can be used to expedite the dissolution process. The resulting solution can be preferably stored in, e.g., a nitrogen-purged glove box, with less than 1 ppm or O₂ and H₂O, to eliminate possible sources of oxygen or water incorporation into the solution. The solution can be centrifuged, e.g., at a speed of about 3000 rpm, for, e.g., about 3 minutes, to remove any suspended or undissolved particulates or impurities.

The solvent in which the glass powder is dissolved is preferably one in which the glass can be dissolved without significant oxide formation. It is found that oxides can be formed on the glass particles when dissolved in hydroxide solutions. It is therefore preferred that the solution be produced with a solvent consisting of an organic liquid having a basic character, such as primary or secondary amines. The solvent is preferably dry, i.e., water-free. All dissolution steps should be performed under a dry inert atmosphere, such as N₂, further to prevent the formation of oxides in the solution.

Examples of suitable solvents include propylamine, H₂N-CH₂-CH₂-CH₃, ethylenediamine, H₂N-CH₂-CH₂-NH₂, and ethanolamine, H₂N-CH₂-CH₂-OH, a range of alcohols, or other suitable fluid. For many applications, propylamine can be the most preferred solvent.

The ratio of glass powder loading to solvent is preferably chosen based on the chemistry of the particular glass and on the particular solvent's properties. For example, a glass composition with high Ge or excess S content, or solvents of low polarity can result in decreased solubility. Also, in order to produce a smoothing layer of relatively large thickness, it is preferable to achieve a high loading of glass powder in solution, to produce a relatively high-viscosity solution and to minimize thinning by solvent evaporation. But it is found than many glass compositions produce precipitates at high glass loadings. Therefore, the glass loading in solution can be said to be optimized when there is included the highest glass content that produces a smoothing layer having substantially the same glass composition as the corresponding bulk glass and that is amenable to solution processing in formation of a smoothing layer on a waveguide core.

It is also to be recognized that the glass loading in solution can influence the efficacy of a selected solution-based application and therefore the intended method of application must be considered, particular with regard to viscosity of the solution. For example, while it is possible to prepare solutions of A_{s42S58} with very high glass loadings, e.g., of up to about 1 g/ml, the viscosity of such solutions is so high as to be unsuitable for spin-coating of the solutions. The selected method of application is therefore to be considered for suitable glass loading level.

For many applications, it can be preferred to experimentally verify the composition of a glass film produced from a given solution of glass powder to determine the degree of fidelity between the composition of the film and the corresponding bulk glass. For the example Ge₂₃Sb₇S₇₀ smoothing layer composition, it is found that for the solvent propylamine, glass loading of about 25 mg/ml can be preferred; it is found that for the solvent ethylenediamine, glass loading of between about 25 mg/ml and about 100 mg/ml can be preferred; and it is found that for the solvent ethanolamine, glass loading of between about 25 mg/ml and about 100 mg/ml can be preferred. For an example smoothing layer composition of As₄₂S₅₈, it is found that for the solvent propylamine, glass loading of between about 25 mg/ml and about 50 mg/ml can be preferred; it is found that for the solvent ethylenediamine, glass loading of between about 25 mg/ml and about 500 mg/ml can be preferred; and it is found that for the solvent ethanolamine, glass loading of between about 25 mg/ml and about 500 mg/ml can be preferred.

The duration of powder dissolution is also important for enabling complete dissolution of elemental constituents and has a direct impact on layer composition. A summary of optimized glass loadings and stir times for the two example smoothing layer compositions described above is given as follows in Table I:

TABLE I

| | As₄₂S₅₈ | | Ge₂₃Sb₇S₇₀ | |
|---|---|---|---|---|
| | Loading | Stir time | Loading | Stir time |
| Solvent | (mg/ml) | (hr) | (mg/mL) | (hr) |
| Propylamine | 50 | 12 | 30 | 48 |
| Ethylenediamine | 100 | 12 | 100 | 12 |
| Ethanolamine | 100 | 6 | 100 | 6 |

By combining an optimized glass loading level with an optimized dissolution duration, it is possible to produce from a glass solution a glassy surface smoothing layer that is substantially identical in composition to the parent bulk glass, within an experimental error of about ±2%. This compositional fidelity has heretofore been unattainable with conventional deposition processes such as thermal evaporation methods.

The speed of stirring is selected based on the glass solution viscosity and on the desired final thickness for the surface smoothing layer. For example, given a selected glass layer composition of Ge₂₃Sb₇S₇₀, a stir speed of about 500 rpm can be preferred.

With a particulate-free solution of suspended glass powder thusly produced, the solution can be applied to a waveguide core as in the final method step illustrated as FIG. 1C. This solution-based application step can be conducted in any suitable manner, and no particular application method is required. Spin coating, sol-gel application, dip-coating, or other solution-based liquid application can be employed.

In an example sol gel process, the desired elemental constituents for a surface smoothing layer, such as a metal alkoxide, are dissolved in a suitable solvent, such as an alcohol, with a co-solvent, such as water, to form a hydrolyzed sol. This sol, when catalyzed by either a base or an acid to assist in network formation, then gels to produce a solid with liquid existing within the resulting pore structure. To form a consolidated, pore-free solid, the solvent and water is removed from the pores of the gel at a temperature that prohibits fracturing of the gel structure, and then the resulting aerogel is densified at a higher temperature.

For many applications, a spin-coating application of the liquid glass solution can be convenient and easily integrated into a waveguide fabrication sequence. In general, in a spin-coating process, the solution including dissolved glass powder is applied to the substrate or other support structure on which one or more waveguide cores are disposed. After a selected duration for the liquid to reach a steady state condition, spinning of the solution-coated substrate is carried out. Then the resulting structure, including the spin-coated layer, is heat-treated. It is found that each of these steps can have a significant influence on the optical and surface quality, as well as uniformity, of the surface smoothing layer to be produced by the spin-coating. It is not possible to define a universal optimal set of spin-coating conditions, but rather, specific characteristics can be identified that are dependent on spin speed, spin duration, wait time after application of solution but before spin, wait time after spin, and heat treatment. For any spin-coat process, it is preferred that the amount of solution applied to the waveguide core prior to the spinning be sufficient to completely cover the waveguide core structure and indeed the entire vicinity of the waveguide core on the substrate or other support structure, with a uniform layer of liquid. For example, liquid application can be accomplished by syringe or other system, preferably fitted with, e.g., a 0.2 μm PTFE inline filter.

It is found that in general, once the liquid solution is applied to the waveguide core structure, the glass layer thickness and the glass layer surface roughness increase as the time between solution application and start of spin increases. Therefore, a minimal pre-spin wait time of, e.g., about 1 sec, can be preferred. For spin-coating application of a surface smoothing layer from solution, the thickness of a smoothing layer derived from a solvent of high vapor pressure such as propylamine is best controlled by varying spin speed, while the thickness of a smoothing layer derived from a low vapor pressure solvent such as ethanolamine and ethylenediamine, is best controlled by reduced spin time, while employing a relatively high spin speed, e.g., greater than 2000 rpm. In general, a spin speed of between about 1000 rpm and about 9000 rpm can be employed.

Depending on the glass composition in solution, a spin time of between about 10 seconds and about 30 seconds can be preferred. For example, for the example As₄₂S₅₈ glass solution in propylamine, a 10 second spin time can be sufficient. For the example Ge₂₃Sb₇S₇₀ solution in propylamine, a spin time of about 20 seconds can be sufficient.

The use of a solvent such as ethanolamine that does not appreciably evaporate during spinning enables the relaxation of spinning-induced thickness variations and surface roughness of the smoothing layer with the incorporation of a post-spin holding period. Specifically, it is found that a significant reduction in RMS surface roughness can be attained by incorporating a post-spin wait period of about 30 seconds after the spin step. This effect is attributed to the low volatility of this solvent, which appears to remain liquid after the spin-coat process. The smoothing effect can be monitored and is apparent to the unaided eye. This reduction in roughness that can be attained for the ethanolamine-derived layer by a post-spin wait period makes the ethanolamine solvent highly attractive as a waveguide surface smoothing layer.

Heat treatment of the surface smoothing layer after solution application and spin-coating on a waveguide core is necessary to remove residual solvent from the smoothing layer and to solidify the layer to fix the morphology of the layer. Because of a possible sensitivity to moisture, a surface smoothing layer should be dried and solidified by a low-temperature heat treatment, such as a soft bake, before removal from an inert atmosphere. For example, exposure to a temperature of between about 60° C. and about 90° C. on a hot plate for a duration between about five minutes and one hour can be sufficient, in a glove box under an N₂ atmosphere. But the moisture sensitivity of the film is only reduced at this step and further exposure to air should preferably be kept short, e.g., to no more than 5-10 minutes, particularly if the humidity is high.

Therefore, it is preferred that immediately after an initial soft-bake step, the coated waveguide core structure be placed in a vacuum oven that is purged with N₂ and evacuated to a pressure of about 1 Torr. The surface smoothing layer is then heated to a temperature of, e.g., between about 90° C. and about 250° C., at a heating ramp rate of about 2-3° C./minute. After reaching the desired hard-bake temperature, the temperature is maintained for a period of between about 1 hour and about 48 hours, and preferably at least eight hours. A hard bake of at least about 8 hours in duration can be preferred to obtain the highest possible density and IR transparency of the surface smoothing layer. If full removal of residual organics is desired, a long hard-bake treatment, e.g., of between about 24 and about 48 hours, can be preferred. At the end of the hard-bake duration, the temperature is then reduced at a ramp rate of, e.g., about 1° C./minute, to a temperature of about 60° C., before removing the coated waveguide structure from the furnace to ambient air.

Crystallization and slow evaporation of the smoothing layer can occur at a hard bake temperature above about 150° C., and thus temperatures much greater than about 150° C., are not in general suitable for some glass layers such as As-based glass layers. For a solvent such as ethanolamine that is characterized by a boiling point above about 150° C., the hard bake step is to be performed under vacuum, e.g., <1 Torr. It can be found in general that vacuum is preferred to an inert atmosphere for any hard bake treatment due to high solvent removal rates. If a solvent is not allowed to diffuse slowly through the smoothing layer, cracking or bubbling of the layer could result, thereby reducing the optical quality of the layer. For this reason, the two-step heat treatment protocol just given above is preferred over a single hard bake treatment, and slow temperature ramp rates of, e.g., about 2-3°/min are preferred. With this protocol, the morphology and properties of the surface smoothing layer correspond well with those of the parent bulk glasses. At the completion of the heat treatment, the waveguide core now as-coated with the surface smoothing layer can then be further processed for fabrication of the intended photonic device or system incorporating the waveguide core.

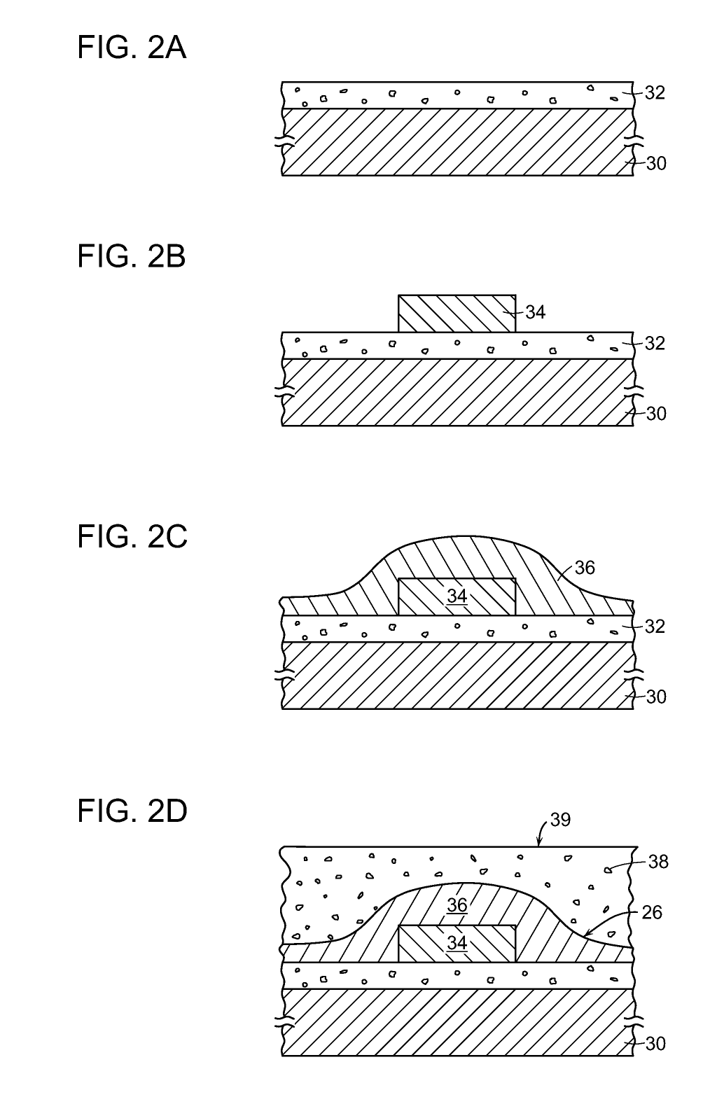

Referring now to FIGS. 2A-2D, the surface smoothing layer production method just described can be incorporated into a waveguide fabrication sequence for any suitable waveguide and set of waveguide materials. In a general procedure for such, referring to FIG. 2A, a suitable substrate 30, such as a quartz or silicon substrate, is provided and a waveguide under-cladding layer 32 is provided on the substrate 30 if desired. Such an undercladding layer is not required and for many applications need not be included. The under-cladding material is selected based on the refractive index of the core material, in the conventional manner, and can be formed of, e.g., an oxide, a nitride, a glass, or other suitable material.

A waveguide core 34 is then formed on the substrate or under-cladding layer 32, e.g., by deposition, lithography, and etching or lift-off processes, in the conventional manner. The waveguide core can be a strip or channel geometry, a rib or ridge geometry, or other selected geometry. The waveguide core can be provided as a selected III-V material such as GaAs, as a selected II-VI material, as Si or Si₃N₄, as SiOₓN_{y}, or other selected core material, including chalcogenide glass materials.

A surface smoothing layer 36 is then formed on the waveguide core 34, e.g., by employing the glassy surface smoothing layer production method just described or other solution-based process such as dip-coating, sol-gel processing, or other solution-based deposition technique. Finally, if desired, an over-cladding layer 38 is formed over the surface smoothing layer. Both the under-cladding and over-cladding layers can be formed of, e.g., an oxide, such as SiOₓ, as a nitride, such as SiNₓ, or other material.

The over-cladding layer thickness can be made sufficient to produce a planar top surface 39 for the waveguide assembly. This is in contrast to the surface 26 of the surface smoothing layer 36, which is not planar and that is characterized by gradually sloping sidewalls that generally follow the geometry of the waveguide core.

In one example application of this waveguide fabrication sequence, the waveguide core and the surface smoothing layer are formed of the same glass composition. For example, both the waveguide core and the glassy surface smoothing layer can be produced with a composition of Ge₂₃Sb₇S₇₀ or other selected glassy material. In general, where the waveguide core is formed of a chalcogenide glass, a metal oxide glass, or a halide glass, there can be provided a corresponding chalcogenide glassy surface smoothing layer. In a further example application of this waveguide fabrication sequence, the waveguide core and the surface smoothing layer are both formed of glasses, but with differing compositions having differing refractive indices, so that the index of the waveguide can be graded from the core material through the smoothing layer material, to the over-cladding material, to reduce the mismatch in indices between core and cladding materials. For example, the waveguide core can be produced with a composition of As₄₂S₄₈, having a refractive index of about 2.4, and the glassy surface smoothing layer produced as a composition of Ge₂₃Sb₇S₇₀, having a refractive index of about 2.2. For this example, the over-cladding layer can be provided as, e.g., a polymer or silicon dioxide, or another chalcogen-containing material.

In the production of a waveguide core of a chalcogenide glass or other glass, a process of thermal evaporation, sputtering, or other selected deposition process can be employed to form the waveguide core material on a substrate or under-cladding layer disposed on a substrate. A bulk glass having a selected glass composition is first prepared in the manner described above, with starting elemental materials melted and mixed, and quenched to form an ingot of bulk glass. The resulting bulk glass material is then employed as a target for sputtering or thermal evaporation.

In one example thermal evaporation process, a substrate, such as a silicon substrate, with or without an undercladding layer as-desired for a given application, is mounted on a thermostat stage and maintained at a selected deposition temperature, such as room temperature, throughout the deposition process. Evaporation from a bulk glass source can be carried out at a base pressure of, e.g., about 2×10⁻⁷ Torr with a selected deposition rate, to produce a selected waveguide core thickness.

With such a thermal evaporation process, the waveguide core geometry can be defined photolithographically, and a selected process such a lift-off process can be employed with the thermal evaporation to form a waveguide core geometry of the selected glassy material. It is known that the optical loss in a waveguide system fabricated by such a photolithography and lift-off sequence is dominated by scattering that is induced by sidewall surface roughness. By employing a glassy surface smoothing layer on the glassy waveguide core, the waveguide core surface is smoothed and, if desired, the index is graded between the core and an upper cladding layer to substantially reduce optical loss due to scattering at the waveguide core surfaces.

### Example

Chalcogenide waveguides having a waveguide core composition of Ge₂₃Sb₇S₇₀ were fabricated and a glassy surface smoothing layer of the same Ge₂₃Sb₇S₇₀ composition was provided for smoothing the sidewalls of the waveguide cores.

Bulk glass with the Ge₂₃Sb₇S₇₀ composition was prepared for use as a thermal evaporation target, in 10 g batches. The starting materials were melted from high-purity elements (Ge—Aldrich, 99.999%, Sb: Alfa, 99.9%, and S—Cerac, 99.999%). The starting materials were weighed in a nitrogen-purged glove box and sealed in a quartz ampoule using a gas-oxygen torch under vacuum. Prior to sealing and melting, the ampoule and the starting materials were preheated to a temperature of 100° C., under high vacuum, for 4 hours to remove surface moisture. The ampoule was then sealed with a gas-oxygen torch and heated to 925° C. to melt for 15 hours. A rocking furnace was used for melting in order to increase the homogeneity of the melt. Once fully homogenized, the melt-containing ampoule was air-quenched to room temperature. To avoid fracture of the tube and glass ingot, the ampoules were subsequently returned to the furnace for annealing for 15 hours at 40° C. below the glass transition temperature.

Silicon substrates of six inch diameter, coated with a 3 μm-thick layer of thermal silicon dioxide (Silicon Quest International Inc.) were employed as the waveguide substrates. Negative photoresist NR9-1000PY (Futurrex Inc.) was employed for photolithography to carry out a lift-off process in formation of waveguide cores, due to the negative-sloping sidewall profile and superior pattern resolution characteristic of this photoresist. The resist was spin-coated onto the substrates using a manual photoresist coater (Model 5110, Solitec, Inc.). UV exposure of the photoresist was carried out using a Nikon NSR-2005i9 i-line wafer stepper. Resist pattern development and subsequent baking were both completed on an SSI 150 automatic photoresist coater/developer track.

Waveguide core layers having a thickness of approximately 400 nm were deposited by thermal evaporation on the patterned photoresist layer over the silicon substrates, using the resulting bulk glass as a thermal evaporation target. The evaporations were carried out in a custom-designed thermal evaporator (112 Evap-Sputter Station from PVD Systems Inc.). The glass waveguide core layers were deposited at a base pressure of 2×10⁻⁷ Torr using a baffled Tantalum source, and the deposition rate was stabilized at 2 nm/s. The Si substrate was mounted on a thermostat stage and was thus maintained at room temperature throughout the deposition process. The glass-coated patterned substrates were then sonicated in acetone to dissolve the photoresist layer beneath the regions of the Ge₂₃Sb₇S₇₀ not forming the waveguide core, thus lifting off those regions. Only the Ge₂₃Sb₇S₇₀ material deposited onto areas not covered by photoresist was retained, and thus a chalcogenide pattern the reverse that of the photoresist was defined. The patterned substrates were then rinsed in methanol and isopropanol to clean the surfaces.

The resulting waveguide cores were then coated with a glassy surface smoothing layer of the Ge₂₃Sb₇S₇₀ composition. To this end, 250 mg of finely ground Ge₂₃Sb₇S₇₀ bulk glass from the bulk preparation described just above was dissolved in propylamine by stirring at 500 rpm for a period of 48 hours, for a concentration of 25 mg/ml. The resulting clear yellow solution was centrifuged in order to remove any particulate matter left after dissolution. Solution coating of the waveguide core structure was performed by applying 1 ml of solution to a 1 cm×2 cm section of the Si substrate and immediately spinning at a selected speed of either 6000 rpm, for a layer thickness of 200 nm, or 9000 rpm, for a layer thickness of 100 nm, both for 30 seconds. At the end of the spin-coat step, the waveguides were then annealed at 90° C. for one hour in nitrogen to stabilize the surface smoothing layer, and then annealed for an additional hour at a temperature of 120° C., 150° C., or 180° C., under vacuum to remove any remaining solvent and to densify the layer.

The surface profiles of the waveguide core sidewalls were recorded before and again after deposition of the glassy surface smoothing layer, using the model TA-2990 micro-thermal analyzer from TA Instrument. The instrument was equipped with a silicon probe, and used as a standard atomic force microscope (AFM). The as-fabricated waveguide core was characterized by a rectangular shape of approximately 500 (±10) nm in width and 200 (±10) nm height. The waveguide core including a surface smoothing layer was characterized by a width of ˜1000 nm and a greater height of approximately 400 (±10) nm. It was found that the waveguide core did not separate from the surrounding layers as the sample was cleaved, indicating good adhesion between the layers.

Energy dispersive X-Ray spectroscopy (EDS) was used during imaging to verify the composition of the surface smoothing layer. The composition of the surface smoothing layer was found to be identical to that of the parent bulk glass, within the error of the measurement (±2 at %) and found to be amorphous.

In order to examine the effect of the surface smoothing layer on the sidewall roughness of the glass waveguides, AFM images of the waveguide surface were collected before and after solution coating to form a surface smoothing layer. A significant amount of roughness was visible on the sidewalls of the bare waveguide core structure. After coating with the surface smoothing layer, the waveguide core profile became more curved, and the width of the waveguide core was significantly increased, in the manner of the schematic view of FIGS. 1C and 2C.

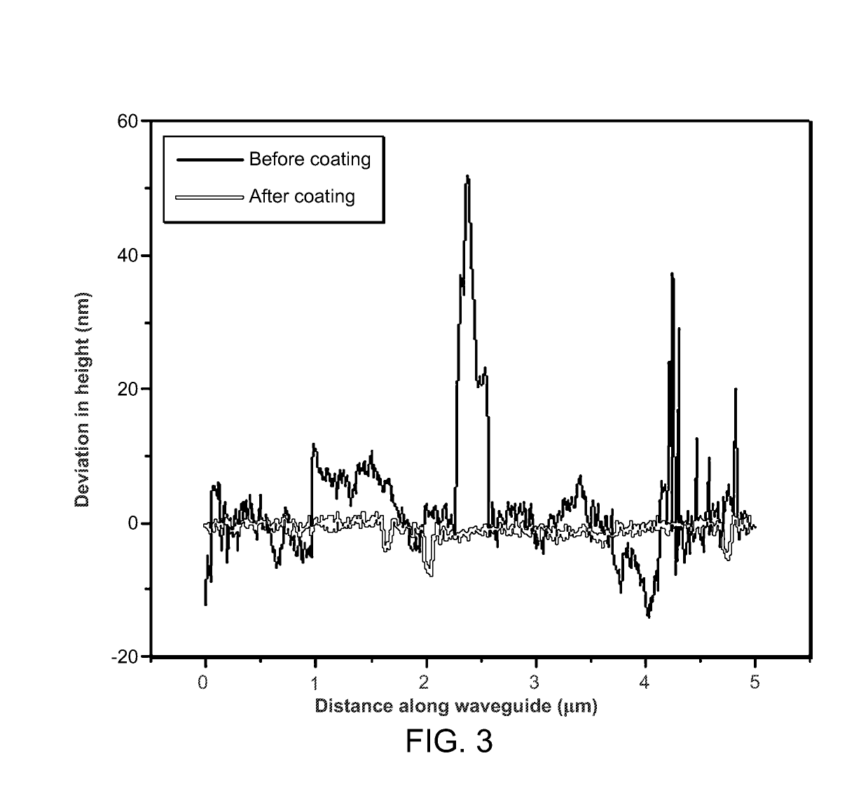

FIG. 3 provides plots of the measured sidewall height vs. distance along a line-scan of one of the fabricated waveguide cores, taken before and then taken after formation of a glassy surface smoothing layer on the waveguide core surface. The sidewall roughness of the waveguide core was estimated by taking the roughness of a single line scan on the side of the waveguide at a site that was approximately ½ of the total height of the waveguide core, and the error was determined by taking three measurements, each on a different waveguide section. The reduction in surface roughness that is provided by the glassy surface smoothing layer is clear from the plotted AFM results. The large number of peaks and valleys up to 50 nm in height on the sidewalls of the uncoated waveguide core were reduced to only a few ˜5 nm valleys after deposition of the surface smoothing layer on the waveguide core. These remaining valleys were later found to correspond to small pores in the surface of the surface smoothing layer. The average RMS sidewall roughness was found to be reduced from 19 (±1) nm to 1.4 (±1) nm by the glassy surface smoothing layer.

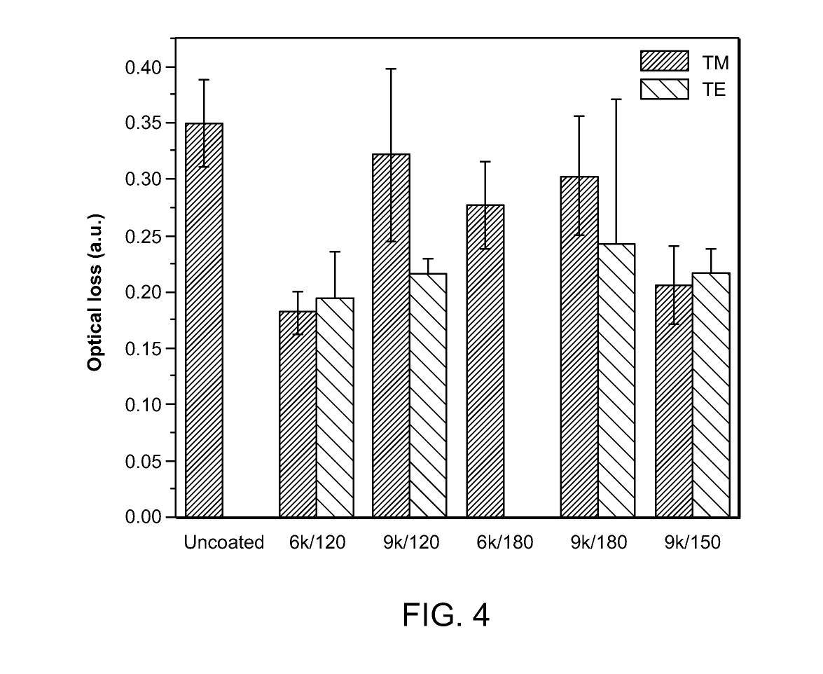

FIG. 4 is a plot of the optical loss for the experimental waveguides, comparing the optical loss for the bare, uncoated waveguide core, and waveguide cores coated with a glassy surface smoothing layer spin-coated at 6000 rpm and 9000 rpm and annealed at temperatures of 120° C., 150° C., or 180° C. The optical loss measurements were performed at a wavelength of 1550 nm using a cut-back passed method. As shown by the plotted loss data, the loss systematically increased as the thickness of the surface smoothing layer was decreased, or the annealing temperature increased, despite similar roughness values for all of the tested waveguides. Because the refractive index of the solution-derived materials has been shown to increase with exposure to higher temperatures, this suggests that there are two mechanisms enabling the optical loss reduction. The first mechanism is through roughness reduction, and the second mechanism is through the increase in waveguide cross-sectional dimension and hence reduced optical mode overlap with the waveguide core sidewalls.

It is also demonstrated by the loss data in the plot that the TE polarization exhibited lower loss than the TM polarization for the waveguide cores including a surface smoothing layer. Given that the TE mode in high-index-contrast waveguides is typically far more susceptible to roughness scattering than the TM mode counterpart, the experimental loss observation suggests that waveguide core sidewall roughness scattering is for these experimental structures becoming insignificant in the overall loss contribution.

With this experimental example and the preceding description, it is demonstrated that a surface smoothing layer deposited from a liquid suspension of glass onto a waveguide core structure significantly reduces the roughness of the waveguide core sidewalls. Rough areas of the sidewalls are filled-in by the solution-based smoothing layer, leading to smoother sidewall features. The surface smoothing layer produces slight changes in the cross-sectional profile of the waveguide core, increasing the cross-sectional dimensions of the waveguide core. With the waveguide core and surface smoothing layer geometry, an optical loss reduction of as much as 50% can be achieved. This optical loss reduction enables the realization of superior performance for a wide range of photonic systems, including lift-off-defined optical systems, such as optical resonators, by producing increased sensitivity though enhanced Q-factor.

It is recognized, that those skilled in the art may make various modifications and additions to the embodiments described above without departing from the spirit and scope of the present contribution to the art. Accordingly, it is to be understood that the protection sought to be afforded hereby should be deemed to extend to the subject matter claims and all equivalents thereof fairly within the scope of the invention.

We claim:

1. An integrated optical waveguide comprising:
a substrate;
a waveguide under-cladding layer disposed on the substrate;
a waveguide core, having sidewall surfaces and a top surface, disposed on the under-cladding layer; and
a glassy surface smoothing layer disposed on the waveguide core top surface and sidewall surfaces, the glassy surface smoothing layer having a refractive index, relative to a refractive index characteristic of the waveguide core, that enables guided optical transmission through the waveguide core and the glassy surface smoothing layer.

2. The waveguide of claim 1 further comprising an upper cladding layer disposed on the glassy surface smoothing layer.

3. The waveguide of claim 1 wherein the glassy surface smoothing layer has a top surface that is characterized by a surface roughness that is less than a surface roughness of the waveguide core sidewall surfaces.

4. The waveguide of claim 1 wherein the refractive index of the glassy surface smoothing layer is substantially equal to the refractive index of the waveguide core.

5. The waveguide of claim 1 wherein the refractive index of the glassy surface smoothing layer and the refractive index of the waveguide core are each greater than a refractive index that is characteristic of the under-cladding layer.

6. The waveguide of claim 2 wherein the refractive index of the glassy surface smoothing layer and the refractive index of the waveguide core are each greater than a refractive index that is characteristic of the upper cladding layer.

7. The waveguide of claim 2 wherein the refractive index of the glassy surface smoothing layer is less than the refractive index of the waveguide core and is greater than a refractive index that is characteristic of the upper cladding layer.

8. The waveguide of claim 1 wherein the refractive index of the glassy surface smoothing layer is greater than about 2.0.

9. The waveguide of claim 1 wherein the glassy surface smoothing layer is an amorphous glass layer.

10. The waveguide of claim 1 wherein the glassy surface smoothing layer and the waveguide core comprise substantially the same material.

11. The waveguide of claim 1 wherein the glassy surface smoothing layer comprises a material selected from the group consisting of chalcogenide glass, heavy metal oxide glass, and halide glass.

12. The waveguide of claim 11 wherein the glassy surface smoothing layer comprises a Ge—Sb—S alloy.

13. The waveguide of claim 11 wherein the glassy surface smoothing layer comprises an As—S alloy.

14. The waveguide of claim 11 wherein the glassy surface smoothing layer comprises an As—Sb—Se—Te alloy.

15. The waveguide of claim 1 wherein the glassy surface smoothing layer is characterized by a thickness that is less than a height of the waveguide core.

16. The waveguide of claim 1 wherein the glassy surface smoothing layer is characterized by tapered smoothing layer sidewalls disposed over the waveguide core sidewalls.

17. The waveguide of claim 1 wherein the waveguide core comprises a chalcogenide glass material.

18. The waveguide of claim 1 wherein the waveguide core comprises a III-V semiconductor material.

19. The waveguide of claim 1 wherein the waveguide core comprises a material selected from the group of silicon and SiOₓN_{Y}.

20. The waveguide of claim 1 wherein the substrate comprises silicon.

21. The waveguide of claim 1 wherein the under-cladding layer comprises an oxide material.

22. The waveguide of claim 1 wherein the waveguide core is characterized by a waveguide geometry selected from the group consisting of channel geometry, strip geometry, ridge geometry, and rib geometry.

23. A method for fabricating an integrated optical waveguide comprising:
forming on a substrate a waveguide under-cladding layer;
forming on the under-cladding layer a waveguide core having sidewall surfaces and a top surface;
applying on the top and sidewall surfaces of the waveguide core a liquid suspension comprising particles of a glassy material; and
heating the applied liquid glassy particle suspension to form a glassy surface smoothing layer on the waveguide core top surface and sidewall surfaces, the glassy surface smoothing layer having a refractive index, relative to a refractive index characteristic of the waveguide core, that enables guided optical transmission through the waveguide core and the glassy surface smoothing layer.

24. The method of claim 23 wherein applying a liquid suspension on the waveguide core comprises spin-coating the liquid suspension on the waveguide core.

25. The method of claim 23 wherein applying a liquid suspension on the waveguide core comprises dip-coating the liquid suspension on the waveguide core.

26. The method of claim 23 wherein applying a liquid suspension on the waveguide core comprises forming a sol gel, from the liquid suspension, on the waveguide core.

27. The method of claim 23 wherein forming a waveguide core comprises thermal evaporation of a glassy material on the under-cladding layer and lift-off lithography to define a waveguide core geometry.

28. The method of claim 23 wherein forming a waveguide core comprises sputtering a glassy material on the under-cladding layer and lift-off lithography to define a waveguide core geometry.

29. The method of claim 23 further comprising forming the liquid suspension of glassy material particles by grinding a bulk glass into glass powder and dissolving the glass powder in a selected solvent.

30. The method of claim 23 wherein applying a liquid suspension on the waveguide core sidewall surfaces comprises coating the liquid suspension over surface topology roughness of the sidewall surfaces to reduce the sidewall surface roughness.

31. The method of claim 23 further comprising forming an upper cladding layer over the glassy surface smoothing layer.

32. The method of claim 23 wherein the glassy surface smoothing layer and the waveguide core comprise substantially the same material.

33. The method of claim 23 wherein the glassy surface smoothing layer comprises a material selected from the group consisting of chalcogenide glass, heavy metal oxide glass, and halide glass.

34. The method of claim 23 wherein the glassy surface smoothing layer is characterized by a thickness that is less than a height of the waveguide core.

35. The method of claim 23 wherein the glassy surface smoothing layer is characterized by tapered smoothing layer sidewalls disposed over the waveguide core sidewalls.

36. The method of claim 23 wherein the waveguide core comprises a chalcogenide glass material.

37. The method of claim 23 wherein the waveguide core comprises a III-V semiconductor material.

38. A method for fabricating an integrated optical waveguide comprising:
forming on a substrate a waveguide under-cladding layer;
forming on the under-cladding layer a first waveguide core region of a first waveguide core region material having a geometry including sidewall surfaces and a top surface;
forming on the first waveguide core region a second waveguide core region by applying on the first waveguide core region top and sidewall surfaces a liquid suspension comprising particles of a glassy material; and
heating the applied liquid glassy particle suspension to form a waveguide core having tapered sidewalls and a refractive index that is substantially equal through the first and second waveguide core regions.

39. The method of claim 38 wherein the glassy material is selected from the group consisting of chalcogenide glass, halide glass, and heavy metal oxide glass.

40. The method of claim 38 wherein the first waveguide core region material and the glassy material comprise chalcogenide glasses.
